(19) United States
(12) Patent Application Publication
(10) Pub. No.: US 2024/0334211 A1
(43) Pub. Date: Oct. 3, 2024

(54) OPTIMIZED STEERING METHODS FOR A STATION IN A MESH NETWORK

(71) Applicant: MediaTek Singapore Pte. Ltd., Singapore (SG)

(72) Inventors: Sonal Arora, Noida (IN); Dipanshu Kumar Mittal, Noida (IN); Amit Shakya, Noida (IN); Prakhar Vig, Noida (IN)

(73) Assignee: MediaTek Singapore Pte. Ltd., Singapore (SG)

(21) Appl. No.: 18/621,093

(22) Filed: Mar. 28, 2024

(30) Foreign Application Priority Data
Mar. 29, 2023 (IN) 202321023269

(51) Int. Cl. H04W 24/02; H04B 17/318; H04W 74/0816

(52) U.S. Cl. CPC H04W 24/02; H04B 17/328; H04W 74/0816

(57) ABSTRACT

A controller within a mesh network includes at least a station (STA) associated with the controller. The controller is arranged to: set a plurality of received signal strength intensity (RSSI) thresholds respectively corresponding to a plurality of operating bands of the controller, when an RSSI of the STA crosses one of the plurality of set thresholds, performing a calculation to determine respective scores of all enabled links of the STA, according to the calculation, determining a best number of spatial streams (NSS) configuration of the STA, and sending an action frame to the STA for informing the STA to update its NSS configuration.

### BACKGROUND

The invention is directed to a mesh network, and more particularly, to a mesh network wherein a controller of the mesh network can perform steering decisions for a station within the mesh network to ensure smooth steering and an improved performance.

Refer to FIG. 1A which is a diagram of a non-access point (AP) multi-link device (MLD) station (herein STA) 100 according to the related art. As shown in the diagram, the STA 100 has two antennae and has triband support meaning it can support all three operating bands of the mesh network, 2.4G, 5G and 6G. The antennae can be configured as (2×2), wherein both antennae are on the same operating band, or configured as (1×1+1×1), wherein each antenna is on a different operating band.

Refer to FIG. 1B, which is a diagram of an AP 200 according to the related art. The AP 200 may be a controller of a mesh network, and comprises six antennae with triband support, wherein each operating band can have a (2×2) configuration. Typically, a STA (such as the STA 100) will be affiliated with a controller (such as the controller 200) within the mesh network, but steering decisions will be made by the STA according to received signal strength intensity (RSSI) measurements from neighbouring APs within the mesh network. These decisions may not give the optimum antenna configuration for the STA or update the antenna configuration at the best time, resulting in insufficient utilization of the available bandwidth. Over time, this can degrade the user experience.

FIG. 2A illustrates one of the issues experienced by the prior art. In FIG. 2A, a mesh network is illustrated comprising a controller and three operating bands, 2.4G, 5G and 6G. A STA is shown moving through the network. At position 1), the STA is in the 6G operating band range and has a (2×2) antenna configuration. When the STA moves into the 5G operating band range at position 2), there will be beacon loss and disconnection on 6G. The antennae will then reconnect on 5G (again, with a (2×2) configuration). When the STA moves into the 2.4G operating range at position 3), there will be beacon loss and disconnection on 5G such that the STA must reconnect on 2.4G. Finally, at position 4), the STA experiences beacon loss and cannot reconnect. The roaming decisions being taken by the STA mean that the STA will undergo repeated disconnection and connection.

Refer to FIG. 2B, which illustrates a STA moving closer to a controller within a mesh network. At position 1), there is no connection. When the STA moves within range of the 2.4G operating band at position 2), initial connection can occur on the 2.4G operating band with both antennae connected. When the STA moves within range of the 5G operating band at position 3), the RSSI of the 2.4G operating band becomes stronger; furthermore, no trigger is received for the STA to upgrade to a 5G (2×2) configuration. Similarly, when the STA moves within range of the 6G operating band at position 4), the RSSI of the 2.4G operating band becomes stronger again and no trigger is received for the STA to upgrade to the 6G operating band, so no upgrade will occur. Thus, even though the STA supports 6G, it will not upgrade its antenna configuration.

Refer to FIG. 2C, which illustrates a STA moving closer to a controller wherein its initial antenna configuration is (2.4G 1×1+5G 1×1). At position 1), the antenna configuration has one antenna operating on the 2.4G band and the other antenna connected to the 5G band. As the STA is not within range of the 5G operating band, only one antenna is usable. At position 2), the second antenna can operate on the 5G band but no decision is made to upgrade the configuration to a 5G (2×2) configuration. Finally, at position 3), even though the STA is in the 6G operating range, the antenna configuration remains 2.4G (1×1) and 5G (1×1).

Refer to FIG. 2D, which illustrates a STA moving through mesh network with a controller and a coupled AP. Initially, the STA has a 2.4G (2×2) configuration at position 1) when it is within the 2.4G operating range of the controller. When the STA moves to position 2), it will be out of range of the controller and will therefore disconnect, even though it is still within range of the coupled AP. Roaming will therefore be activated, and it will reconnect at position 3) with the coupled AP, but this connection may not have the optimal antenna configuration. Further, the STA will also keep making measurements to improve its AP connectivity which causes the battery to drain.

Therefore, there is a need to provide solutions for a mesh network with a moving STA, which can optimize the antenna configuration of the STA and improve a user experience.

### SUMMARY

This in mind, the invention provides a controller and a method for operating the same, which can achieve smooth steering of a STA within a mesh network to thereby improve a user experience and optimize the antenna configuration of the STA.

A controller within a mesh network according to an exemplary embodiment of the present invention comprises at least a station (STA) associated with the controller. The controller is arranged to: set a plurality of received signal strength intensity (RSSI) thresholds respectively corresponding to a plurality of operating bands of the controller, when an RSSI of the STA crosses one of the plurality of set thresholds, performing a calculation to determine respective scores of all enabled links of the STA, according to the calculation, determining a best number of spatial streams (NSS) configuration of the STA, and sending an action frame to the STA for informing the STA to update its NSS configuration.

The controller is further arranged to perform a calculation to determine respective scores of all supported links of the STA, and according to the calculation, determine a best band of operation of the NSS configuration, wherein the action frame further informs the STA which band value to use with which NSS link.

In one embodiment, the mesh network further comprises an access point (AP) not associated with the STA, the controller is arranged to define a current RSSI of the STA with the controller, a current RSSI of the STA with the non-associated AP, and a plurality of thresholds respectively associated with operating bands of the AP, when the current RSSI of the STA with the controller is less than the current RSSI of the STA with the non-associated AP, the controller compares the plurality of thresholds respectively associated with operating bands of the AP with the current RSSI of the STA with the non-associated AP and sends a request instructing the STA to connect to the AP.

A method for updating an NSS configuration of a STA associated with a controller within a mesh network according to an exemplary embodiment of the present invention comprises: utilizing the controller to set a plurality of received signal strength intensity (RSSI) thresholds respectively corresponding to a plurality of operating bands of the controller; when an RSSI of the STA crosses one of the plurality of set thresholds, performing a calculation to determine respective scores of all enabled links of the STA; according to the calculation, determining a best number of spatial streams (NSS) configuration of the STA; and sending an action frame to the STA for informing the STA to update its NSS configuration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram of a non-AP according to the related art.

FIG. 1B is a diagram of an AP according to the related art.

FIG. 2A is an illustration of a STA moving within a mesh network according to a first scenario of the related art.

FIG. 2B is an illustration of a STA moving within a mesh network according to a second scenario of the related art.

FIG. 2C is an illustration of a STA moving within a mesh network according to a third scenario of the related art.

FIG. 2D is an illustration of a STA moving within a mesh network according to a fourth scenario of the related art.

FIG. 3A is a diagram of a STA coupled to a controller via a first NSS configuration.

FIG. 3B is a diagram of the STA illustrated in FIG. 3A receiving an action frame from the controller according to an exemplary embodiment of the invention.

FIG. 3C is a diagram of the STA illustrated in FIG. 3A updating its NSS configuration according to the action frame received from the controller according to an exemplary embodiment of the invention.

FIG. 4 is a flowchart of a method according to an exemplary embodiment of the invention.

FIG. 5 is a diagram of RSSI thresholds set by a controller in a mesh network according to an exemplary embodiment of the invention.

FIG. 6 is a diagram of steering decisions made by a controller for a STA moving through a mesh network according to a first embodiment of the invention.

FIG. 7 is a diagram of steering decisions made by a controller for a STA moving through a mesh network according to a second embodiment of the invention.

FIG. 8 is a diagram of RSSI thresholds set by a controller in a mesh network including an AP according to an exemplary embodiment of the invention.

FIG. 9 is a diagram of steering decisions made by a controller for a STA moving through the mesh network illustrated in FIG. 8 according to a third embodiment of the invention.

FIG. 10 is a flowchart of a method for performing steering decisions according to the third embodiment of the invention.

FIG. 11A is a diagram of a modified operating mode notification action frame according to an exemplary embodiment of the present invention.

FIG. 11B is a diagram of a modified BTM request according to an exemplary embodiment of the present invention.

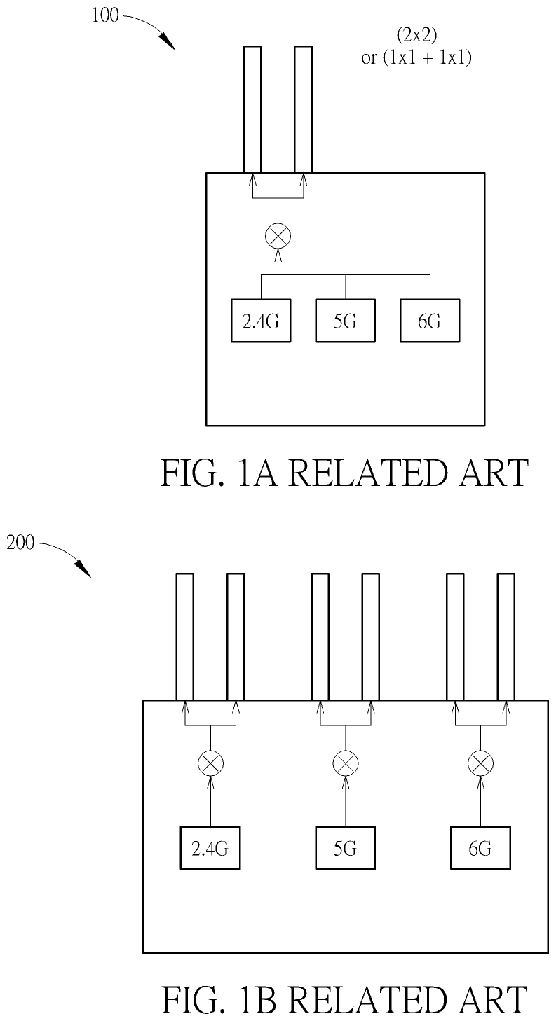

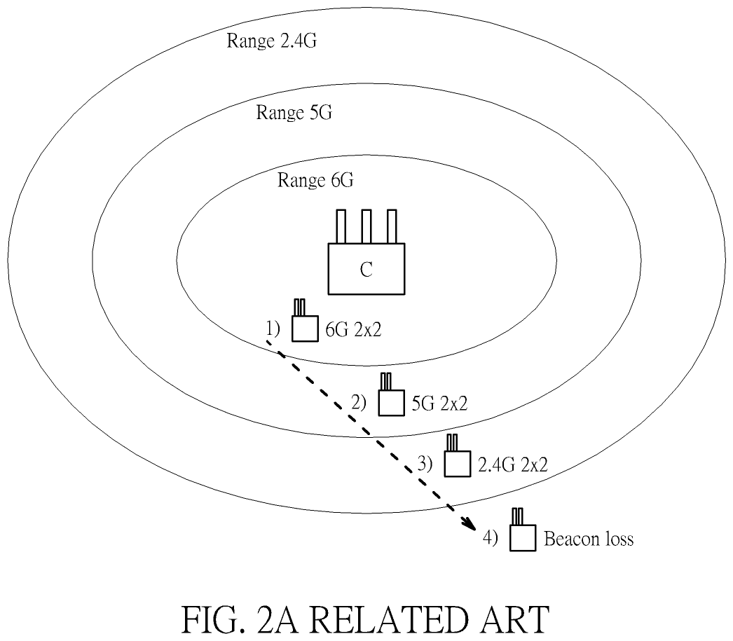

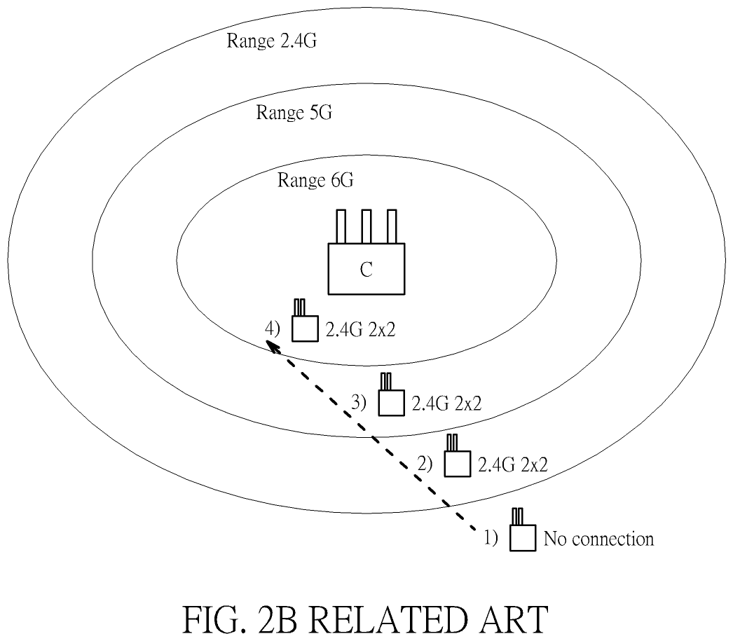

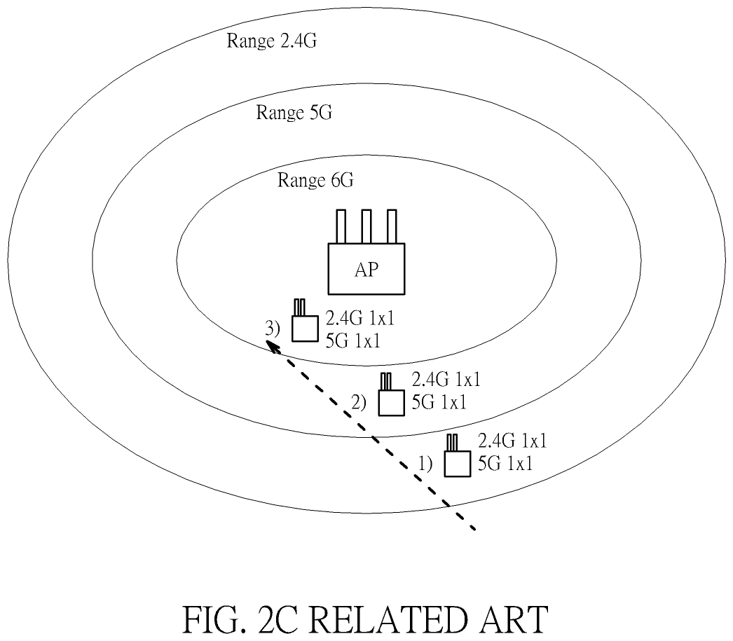

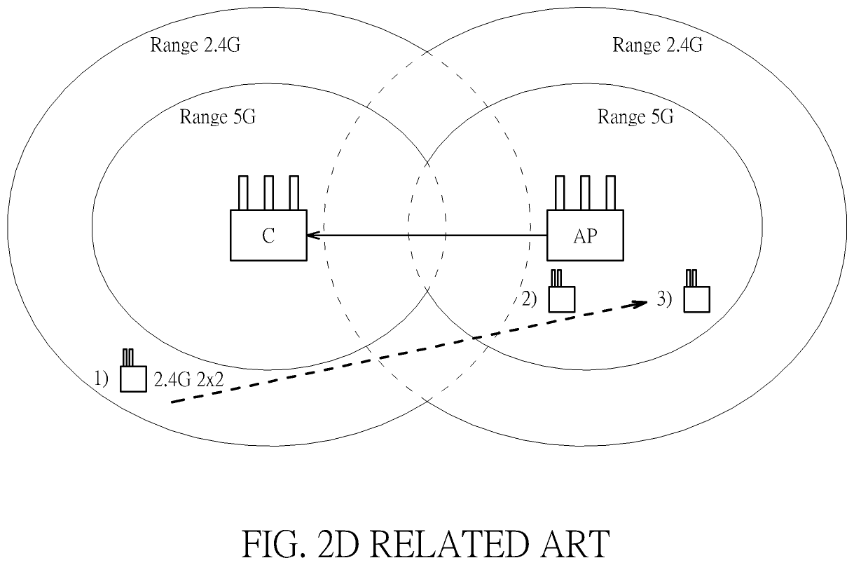

### DETAILED DESCRIPTION

The present invention enables a controller of a mesh network to perform steering decisions for a STA moving within the mesh network. As the controller of a mesh network has all information regarding links and capabilities of STAs connected to any device within the mesh network, the controller can make a decision to steer a STA from one band to another band (band steering) or from one device to another (multi-AP steering). The steering decision is made according to RSSI measurements and RSSI thresholds set by the controller. The STA receives action frames from the controller including neighbour and channel information of a target BSS selected by the controller, enabling it to update its antenna configuration to an optimized configuration.

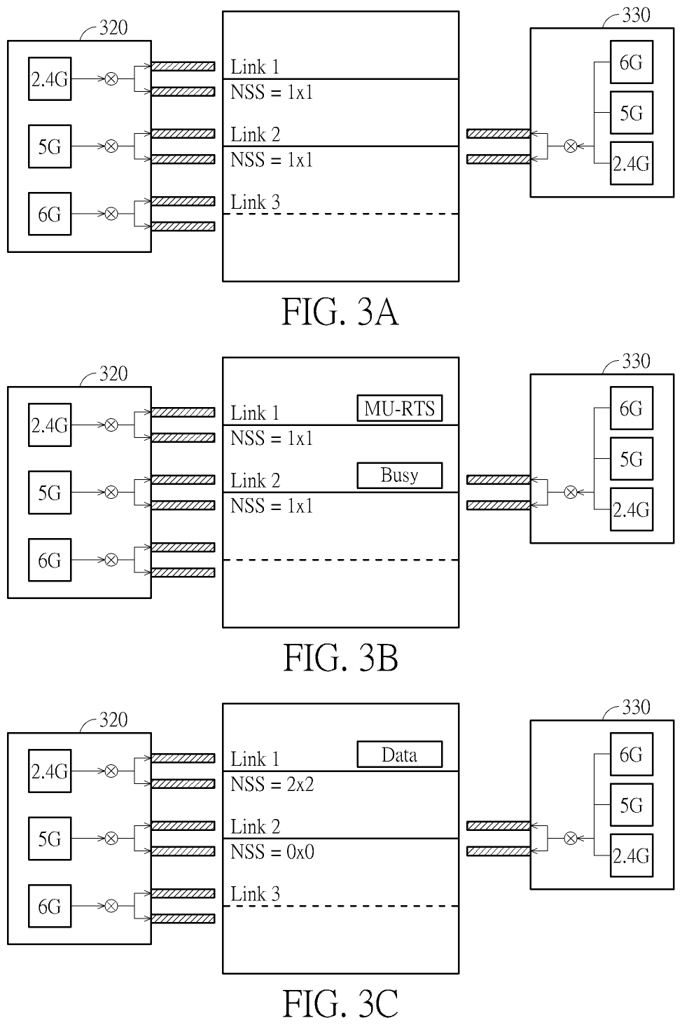

Refer to FIG. 3A which illustrates a controller 320 configuring an antenna link of a STA 330. Initially, the STA has a (1×1+1×1) configuration, with one link on 2.4G, the other link on 5G, and the 6G link disabled. FIG. 3B illustrates an MU-RTS frame being sent on the 2.4G link, wherein the MU-RTS frame informs the STA 330 that the 5G link is busy, and it therefore must update its NSS configuration so that both antenna operate on the 2.4G link, in order to optimize the STA capabilities. Refer to FIG. 3C, wherein the STA 330 now has a (2×2) configuration on the 2.4G link, and data can be received on the same link.

In order to make decisions regarding an antenna configuration for the STA, the controller first sets a plurality of RSSI thresholds corresponding to the operating bands of the mesh network. The RSSI of the STA connected to the controller is received by the controller. When the RSSI exceeds or goes below one of the plurality of set RSSI thresholds, the controller can enter a steering algorithm for determining a best antenna configuration for the STA. The best antenna configuration can be a configuration suitable for the connection or a configuration with a best or allowable performance. This determination involves computing scores for each of the available links, and selecting a best link therein.

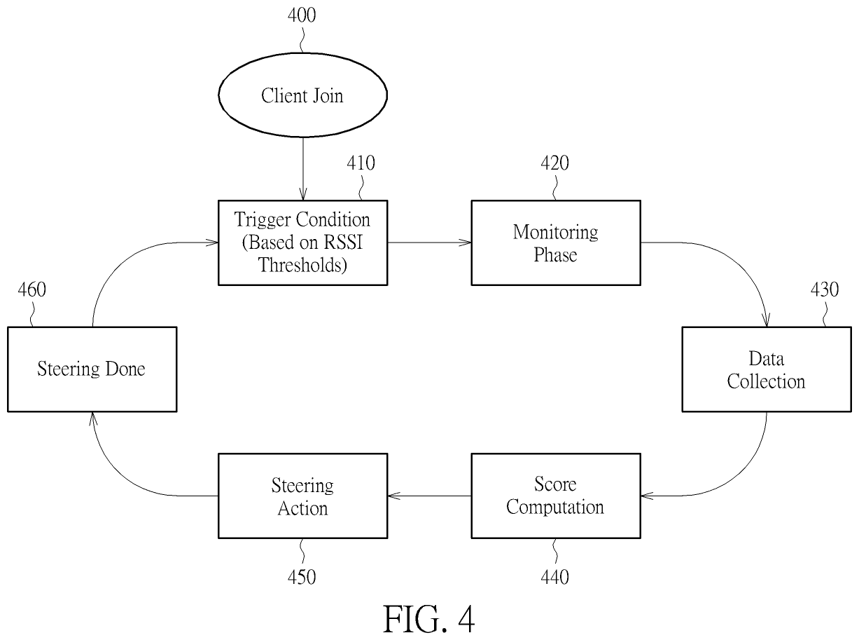

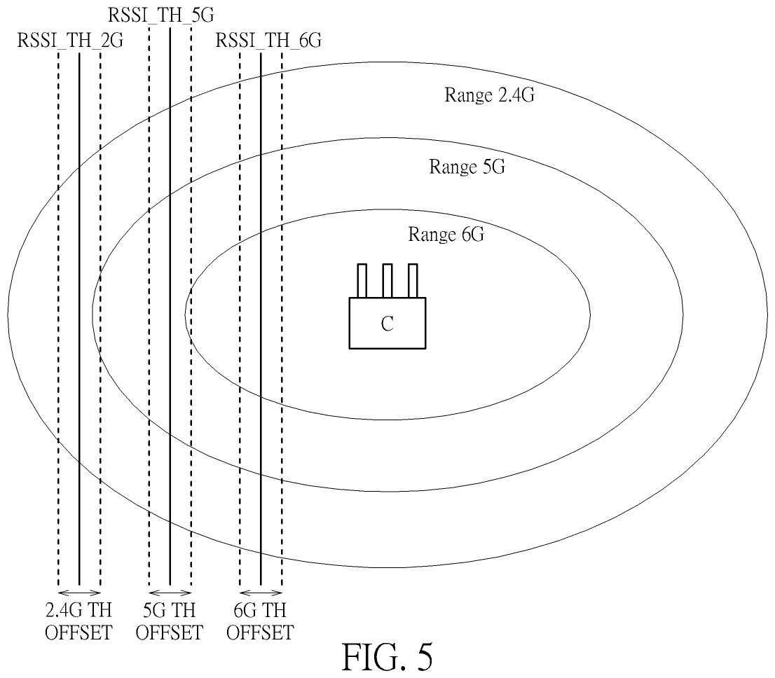

Refer to FIG. 4, which is a flowchart of the steering process of the controller. The steps are as follows:
Step 400: STA joins mesh network
Step 410: Trigger condition occurs based on RSSI thresholds
Step 420: Controller enters monitoring phase
Step 430: Controller performs data collection
Step 440: Controller performs score computation
Step 450: Controller performs steering action for STA
Step 460: Steering completed

The RSSI thresholds are defined for each operating band. The score computation indicates when the RSSI of the STA on one operating band will be better than the RSSI of the STA on another operating band. The controller can use the score computation to determine an optimal antenna configuration for the STA. In addition, the invention defines a plurality of offsets for each RSSI threshold, in order to prevent over frequent trigger conditions. The RSSI thresholds and offsets are illustrated in FIG. 5. The offsets can be set according to user preferences or device settings and can be variable. In the example shown in FIG. 5, the dotted line to the right of the 6G threshold (illustrated by the solid line RSSI_TH_6G) indicates RSSI_TH_6G+RSSI_TH_OFFSET, and the dotted line to the left of the 6G threshold indicates RSSI_TH_6G−RSSI_TH_OFFSET. The offsets for the other operating bands can be inferred from the above example.

As illustrated in FIG. 4, when a trigger condition is met, the controller will perform data collection and score computation in order to perform a steering action for the STA, of which three different steering methods for a STA moving within a mesh network are provided.

In a first method, the controller is able to decide a best number of spatial streams (NSS) antenna configuration for the STA according to the initially enabled antenna links of the STA. For example, if the STA connects to the controller with a 2.4G (1×1) and a 5G (1×1) configuration, the controller can maintain the configuration or instruct the STA to operate on a 2.4G (2×2) configuration or a 5G (2×2) configuration, but cannot instruct the STA to switch to the 6G operating band. As illustrated in FIG. 3B, the controller can send an MU-RTS frame to the STA for informing the STA of the best NSS configuration. The best NSS configuration can be a configuration suitable for the connection or a configuration with a best or allowable performance.

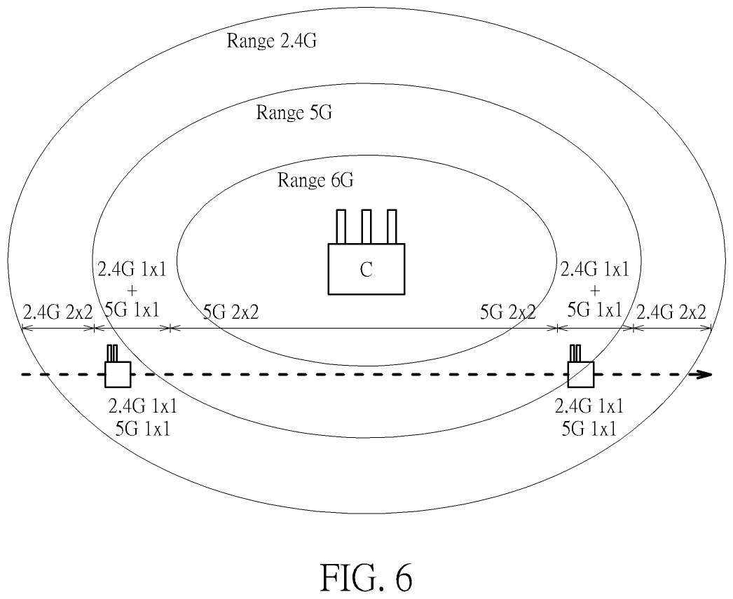

This steering method is illustrated in FIG. 6. As shown in the diagram, the STA initially connects to the controller with a 2.4G (1×1)+5G (1×1) configuration, such that only the 2.4G and 5G links are enabled. The dashed line illustrates the STA moving through the mesh network. Once the STA enters within range of the 5G operating band, the controller can instruct the STA to switch to a 5G (2×2) configuration, but when the STA enters the 6G operating band it must maintain this configuration as the 6G link is not enabled. Once the STA starts to leave the 5G operating band range, the controller will instruct it to revert to the 2.4G (1×1)+5G (1×1) configuration, and then instruct it to enable the 2.4G (2×2) configuration once it fully enters the 2.4G operating band range.

Table 1 illustrates trigger conditions for the above case, including the trigger frame and the final antenna configuration. As detailed above, the RSSI thresholds and offsets can be varied according to a user preference.

TABLE 1

| Link | Current Band | Trigger Condition | Triggered | |
|---|---|---|---|---|
| Enable | (Initial State) | (RSSI change) | frame | Final State |
| 5G + 2G | 5G (2 × 2) | RSSI_Current > | N/A | Same (5G |
| | | (RSSI_TH_5G + | | (2 × 2)) |
| | | RSSI_TH_OFFSET) | | |
| 5G + 2G | 5G (2 × 2) | RSSI_Current < | MU-RTS | Change (5G |
| | | (RSSI_TH_5G − | | (1 × 1) + 2G |
| | | RSSI_TH_OFFSET) | | (1 × 1)) |
| 5G + 2G | 5G (1 × 1) + | RSSI_Current < | MU-RTS | Change (2G |
| | 2G (1 × 1) | (RSSI_TH_2G − | | (2 × 2)) |
| | | RSSI_TH_OFFSET) | | |
| 5G + 2G | 2G (2 × 2) | RSSI_Current > | MU-RTS | Change (5G |
| | | (RSSI_TH_2G + | | (1 × 1) + 2G |
| | | RSSI_TH_OFFSET) | | (1 × 1)) |
| 5G + 2G | 5G (1 × 1) + | RSSI_Current > | MU-RTS | Change (5G |
| | 2G (1 × 1) | (RSSI_TH_5G + | | (2 × 2)) |
| | | RSSI_TH_OFFSET) | | |
| 5G + 2G | 2G (2 × 2) | RSSI_Current < | N/A | Same (2G |
| | | (RSSI_TH_2G − | | (2 × 2)) or |
| | | RSSI_TH_OFFSET) | | disconnection |
| 5G + 6G | 6G (2 × 2) | RSSI_Current > | N/A | Same (6G |
| | | (RSSI_TH_6G + | | (2 × 2)) |
| | | RSSI_TH_OFFSET) | | |
| 5G + 6G | 6G (2 × 2) | RSSI_Current < | MU-RTS | Change (6G |
| | | (RSSI_TH_6G − | | (1 × 1) + 5G |
| | | RSSI_TH_OFFSET) | | (1 × 1)) |
| 5G + 6G | 6G (1 × 1) + | RSSI_Current < | MU-RTS | Change (5G |
| | 5G (1 × 1) | (RSSI_TH_5G + | | (2 × 2)) |
| | | RSSI_TH_OFFSET) | | |
| 5G + 6G | 5G (2 × 2) | RSSI_Current > | MU-RTS | Change (6G |
| | | (RSSI_TH_6G − | | (1 × 1) + 5G |
| | | RSSI_TH_OFFSET) | | (1 × 1)) |
| 5G + 6G | 6G (1 × 1) + | RSSI_Current > | MU-RTS | Change (6G |
| | 5G (1 × 1) | (RSSI_TH_6G + | | (2 × 2)) |
| | | RSSI_TH_OFFSET) | | |
| 5G + 6G | 5G (2 × 2) | RSSI_Current > | N/A | Same (5G |
| | | (RSSI_TH_5G + | | (2 × 2)) |
| | | RSSI_TH_OFFSET)&& | | |
| | | RSSI_Current < | | |
| | | (RSSI_TH_6G − | | |
| | | RSSI_TH_OFFSET) | | |

Although the above method can achieve a better performance as compared to the related art, the controller is limited to the links enabled by the initial antenna configuration when the STA connects to the controller. As the STA supports triband, it would be preferable if the operating band can be changed.

A second embodiment of the present invention therefore provides a method for performing steering control of a STA wherein both the NSS configuration and the band of operation can be changed by the controller. The MU-RTS frame is not able to carry this information; therefore, the present invention defines an action frame as a reverse operating mode notification (Reverse OMN frame) which can be sent from the controller to the STA. The reverse OMN frame will be detailed later.

The thresholds defined previously can be used for this embodiment, wherein the controller triggers the steering algorithm in the same way. Additionally, the controller can also send a TID to link mapping trigger frame for informing the STA of the band switching, and then send the MU-RTS frame as detailed above in order to inform the STA of the new NSS configuration, rather than sending the reverse OMN frame.

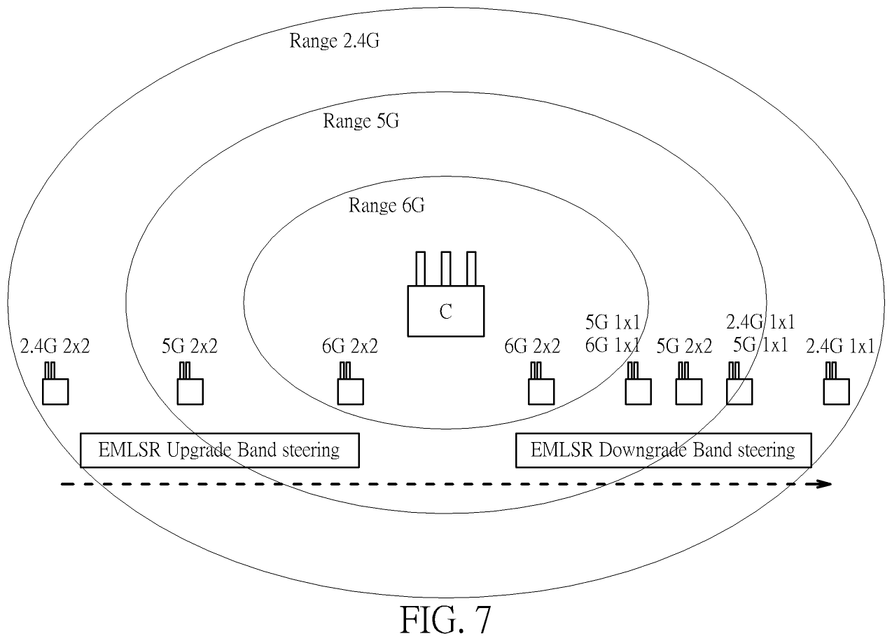

Refer to FIG. 7, which illustrates a STA moving through a network according to this embodiment. As shown in the diagram, the STA initially connects to the controller with a 2.4G (2×2) configuration. When the STA enters the 5G operating range, the controller can steer the STA to have a 5G (2×2) configuration as in the previous embodiment, but when the STA enters the 6G operating range, the band steering method of this embodiment can enable the STA to switch to a 6G (2×2) configuration via the reverse OMN frame.

In the above, the controller instructs the STA to maintain a (2×2) NSS configuration as the RSSI gets stronger, such that the STA antenna configuration will be 2G (2×2)→5G (2×2)→6G (2×2). When the STA moves away from the controller, the downgrade will be done in phases, i.e. 6G (2×2)→6G (1×1)+5G (1×1)→5G (2×2) etc. This is done to maintain the advantages of the higher operating band for as long as possible.

The following table shows the trigger conditions for the above embodiment, wherein the RSSI thresholds are as defined for the first embodiment.

TABLE 2

| Link | Current band | Triggering condition | Triggered | |
|---|---|---|---|---|
| enable | (initial state) | (RSSI change) | frame | Final state |
| 2G + | 2G (2 × 2) | RSSI_Current > | Reverse | Change (5G |
| 5G | | (RSSI_2G_TH + | OMN | (2 × 2)) |
| | | RSSI_TH_OFFSET) | | |
| 5G + | 5G (2 × 2) | RSSI_Current > | Reverse | Change (6G |
| 5G | | (RSSI_6G_TH + | OMN | (2 × 2)) |
| | | RSSI_TH_OFFSET) | | |
| 6G + | 6G (2 × 2) | RSSI_Current > | N/A | Same (6G |
| 6G | | (RSSI_6G_TH + | | (2 × 2)) |
| | | RSSI_TH_OFFSET) | | |
| 6G + | 6G (2 × 2) | RSSI_Current < | Reverse | Change (6G |
| 6G | | (RSSI_6G_TH − | OMN | (1 × 1) + 5G |
| | | RSSI_TH_OFFSET) | | (1 × 1)) |
| 5G + | 6G (1 × 1) + | RSSI_Current < | MU-RTS | Change (5G |
| 6G | 5G (1 × 1) | (RSSI_5G_TH + | | (2 × 2)) |
| | | RSSI_TH_OFFSET) | | |
| 5G + | 5G (2 × 2) | RSSI_Current < | Reverse | Change (5G |
| 2G | | (RSSI_2G_TH + | OMN | (1 × 1) + 2G |
| | | RSSI_TH_OFFSET) | | (1 × 1)) |
| 5G + | 5G (1 × 1) + | RSSI_Current < | MU-RTS | Change (2G |
| 2G | 2G (1 × 1) | (RSSI_2G_TH − | | (2 × 2)) |
| | | RSSI_TH_OFFSET) | | |
| 5G + | 2G (2 × 2) | RSSI_Current > | MU-RTS | Change (5G |
| 2G | | (RSSI_5G_TH − | | (1 × 1) + 2G |
| | | RSSI_TH_OFFSET | | (1 × 1)) |
| 5G + | 5G (1 × 1) + | RSSI_Current > | MU-RTS | Change (5G |
| 2G | 2G (1 × 1) | (RSSI_2G_TH + | | (2 × 2)) |
| | | RSSI_TH_OFFSET | | |

This embodiment overcomes the disadvantages of the first embodiment in that both the NSS configuration and the operating band of the STA can be changed. This enables the STA to achieve a better performance for a longer time as compared to the first embodiment. If, however, the STA moves almost out of range of the controller but is within range of an AP within the mesh network, the STA may maintain the lower operating band connection with the controller even when connecting with the AP would give higher performance. Further, when the STA moves totally out of range of the controller, the STA must first disconnect from the controller due to the connection being maintained, and will then perform roaming to attempt connection with the AP.

In order to overcome this disadvantage, a third embodiment is proposed by the invention. In this embodiment, the controller computes scores for an RSSI of the STA with the controller and an RSSI of the STA with an AP within the mesh network to determine which multi-link device the STA should connect to. The controller must therefore define a number of other parameters including an RSSI of the STA with the currently associated controller, an RSSI of the STA with a candidate unassociated AP, a plurality of RSSI MAP thresholds, which define when an RSSI of the STA in one band of the AP is better than an RSSI of the STA in another band of the AP, as well as a plurality of offsets associated with the RSSI MAP thresholds. The RSSI of the STA with respect to the unassociated AP can be determined by sending a request to the STA. The controller sends an enhanced multi-link single radio (EMLSR) frame to the STA when its RSSI crosses one of the thresholds, wherein the EMLSR can enable dynamic switching across multiple bands.

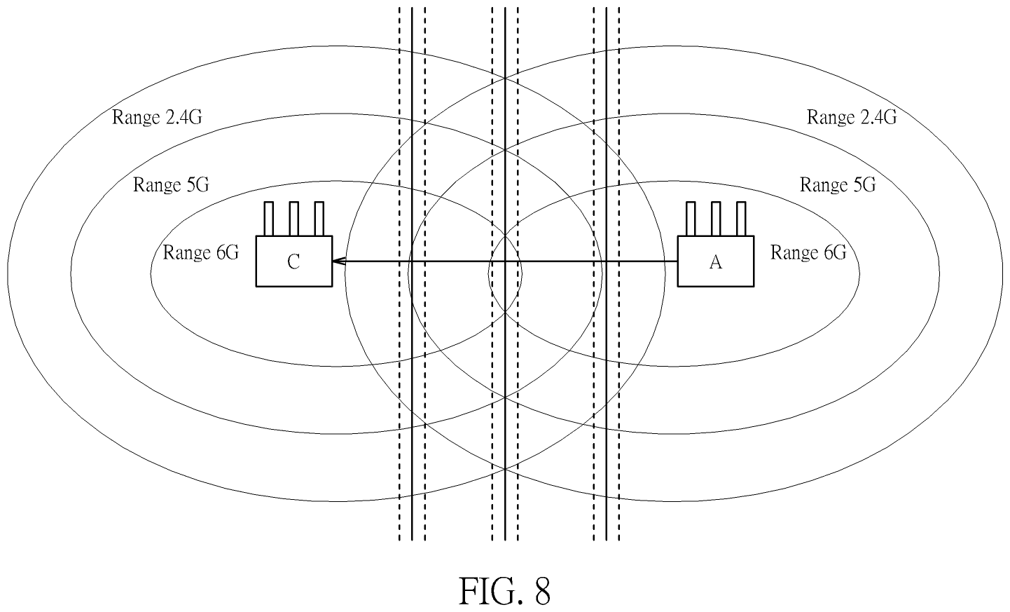

Refer to FIG. 8, which illustrates a mesh network comprising both a controller and an AP. The RSSI thresholds are illustrated, wherein the RSSI thresholds of the controller are the same as those illustrated in FIG. 5, the multi-AP (MAP) thresholds for all three operating bands are illustrated by solid lines, and the MAP threshold offsets for all three operating bands are illustrated by dashed lines.

TABLE 3

| Link | Current Band | Triggering condition | Triggered | |
|---|---|---|---|---|
| enable | (initial state) | (RSSI change) | frame | Final state |
| 5G + 5G | 5G (2 × 2) | RSSI_Current < | EMLSR BTM | Change |
| | | (RSSI_5G_TH − | | controller |
| | | RSSI_TH_OFFSET) && | | to AP and 6G |
| | | RSSI_Current_AP2 > | | (2 × 2) |
| | | (RSSI_MAP_6G_TH + | | |
| | | RSSI_MAP_TH_OFFSET) | | |
| 5G + 5G | 5G (2 × 2) | RSSI_Current < | EMLSR BTM | Change |
| | | (RSSI_5G_TH − | | controller |
| | | RSSI_TH_OFFSET) && | | to AP and 5G |
| | | RSSI_Current_AP2 > | | (2 × 2) |
| | | (RSSI_MAP_5G_TH + | | |
| | | RSSI_MAP_TH_OFFSET) | | |
| 5G + 6G | 6G (1 × 1) + | RSSI_Current < | EMLSR BTM | Change |
| | 5G (1 × 1) | (RSSI_6G_TH − | | controller |
| | | RSSI_TH_OFFSET) && | | to AP and 6G |
| | | RSSI_Current_AP2 > | | (2 × 2) |
| | | (RSSI_MAP_6G_TH + | | |
| | | RSSI_MAP_TH_OFFSET) | | |
| 2G + 5G | 5G (1 × 1) + | RSSI_Current < | EMLSR BTM | Change |
| | 2G (1 × 1) | (RSSI_5G_TH − | | controller |
| | | RSSI_TH_OFFSET) && | | to AP and 6G |
| | | RSSI_Current_AP2 > | | (2 × 2) |
| | | (RSSI_MAP_6G_TH + | | |
| | | RSSI_MAP_TH_OFFSET) | | |
| 2G + 5G | 5G (1 × 1) + | RSSI_Current < | EMLSR BTM | Change |
| | 2G (1 × 1) | (RSSI_5G_TH − | | controller |
| | | RSSI_TH_OFFSET) && | | to AP and 5G |
| | | RSSI_Current_AP2 > | | (2 × 2) |
| | | (RSSI_MAP_5G_TH + | | |
| | | RSSI_MAP_TH_OFFSET) | | |
| 2G + 2G | 2G (2 × 2) | RSSI_Current < | EMLSR BTM | Change |
| | | (RSSI 2G_TH − | | controller |
| | | RSSI_TH_OFFSET) && | | to AP and 6G |
| | | RSSI_Current_AP2 > | | (2 × 2) |
| | | (RSSI_MAP_6G_TH + | | |
| | | RSSI_MAP_TH_OFFSET) | | |
| 2G + 2G | 2G (2 × 2) | RSSI_Current < | EMLSR BTM | Change |
| | | (RSSI_2G_TH − | | controller |
| | | RSSI_TH_OFFSET) && | | to AP and 5G |
| | | RSSI_Current_AP2 > | | (2 × 2) |
| | | (RSSI_MAP_5G_TH + | | |
| | | RSSI_MAP_TH_OFFSET) | | |
| 2G + 2G | 2G (2 × 2) | RSSI_Current < | EMLSR BTM | Change |
| | | (RSSI_2G_TH − | | controller |
| | | RSSI_TH_OFFSET) && | | to AP and 5G |
| | | RSSI_Current_AP2 > | | (1 × 1) + 2G |
| | | (RSSI_MAP_5G_TH + | | (1 × 1) |
| | | RSSI_MAP_TH_OFFSET) | | |

When the STA is connected to the controller, the controller can communicate a steering decision to the STA by sending a BTM request. If, however, the STA is connected to the AP, the steering decisions will still be made by the controller. In this case, the controller will send a mandate steering request to the agent, which will send a BTM to the STA for communicating the steering decision. The BTM request and mandate steering request already exist in the art, but are enhanced to contain the extra information required for the steering operation.

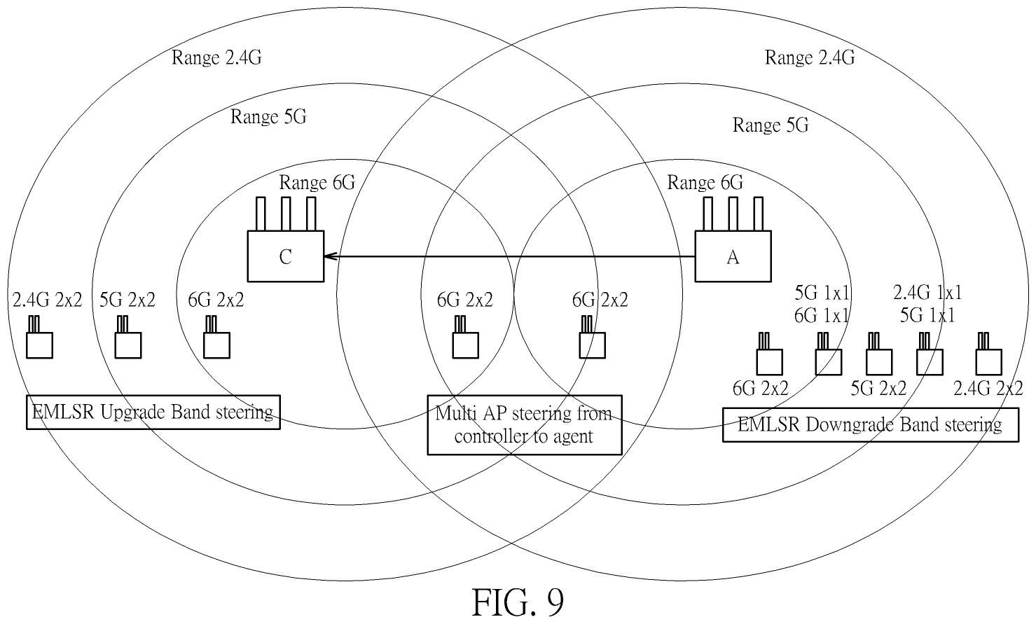

Refer to FIG. 9, which illustrates an STA moving within a mesh network comprising a controller and an AP. As shown in the diagram, the STA initially moves towards the controller, and the controller can perform the upgrade band steering according to the second embodiment. When the STA starts to move away from the controller, the STA will leave the 6G operating range of the controller. If the method of the second embodiment were used at this point, the NSS and band configuration of the STA would be downgraded, either to a 6G (1×1)+5G (1×1) configuration, or to a 5G (2×2) configuration. As the STA is still within the 6G operating range of the AP, however, the controller can make the decision to steer the STA to the AP, enabling it to remain on the 6G operating band. This is determined according to the score computation performed by the controller.

When the result of the score computation is that the STA should connect to the AP, the controller will send a BTM request to the STA. The STA will then connect to the AP, and remains connected as it moves away from the AP. The method of the second embodiment can be used to downgrade the band steering of the AP. When the STA moves out of range of both the controller and the AP, it will be disconnected. In this way, the STA can be steered to the AP before the link quality starts to degrade, such that the user experience can be optimized.

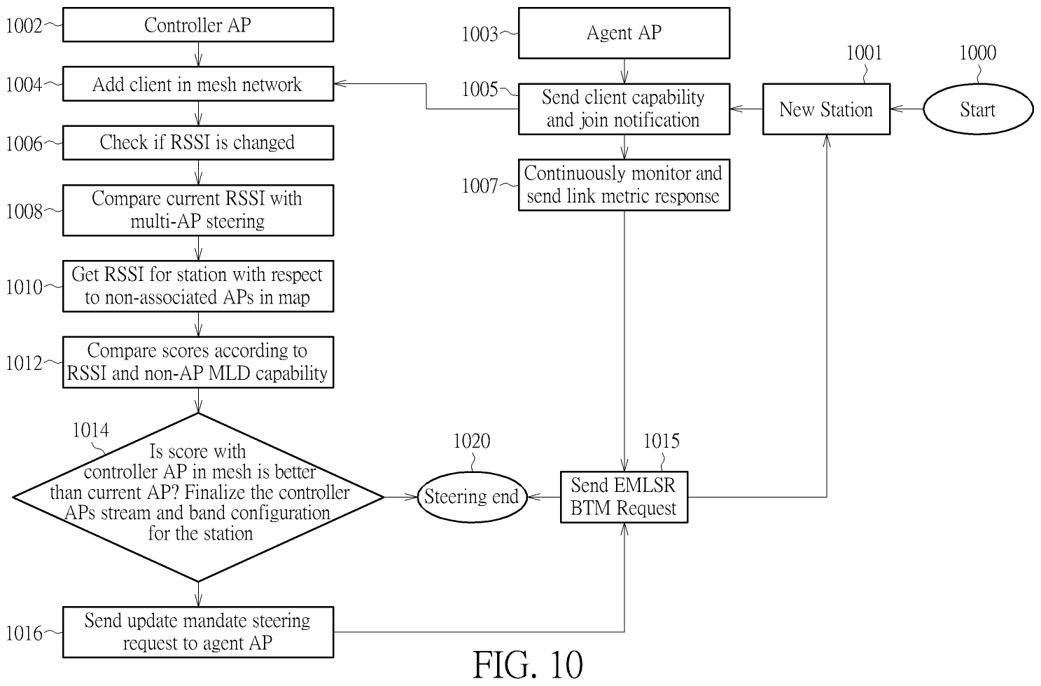

FIG. 10 illustrates a method according to the third embodiment of the invention. In Step 1000, the flow begins. In Step 1001, a STA enters the mesh network. In Step 1003, an AP joins the mesh network. In Step 1005, the AP sends client capability and a join notification. In Step 1007, the AP continuously monitors and sends a link metric response. In Step 1015, a BTM request is sent to the STA.

In Step 1002, the controller configures the mesh network. In Step 1004, the STA is added to the mesh network by the controller. In Step 1006, the controller checks whether an RSSI of the STA has changed. In Step 1008, the current RSSI of the STA is compared with the defined thresholds. In Step 1010, the controller compares scores of the STA according to RSSI and the AP RSSI. In Step 1012, the controller determines which score is better, and finalizes the stream and band configuration for the STA. If the AP score is better, in Step 1016 the controller sends an update mandate steering request to the AP. If the AP score is not better, the flow proceeds to Step 1020 and the steering ends.

In all embodiments, the controller must perform score computation to determine at least a best NSS configuration for the STA, as well as a best operating band in the second embodiment, and a best device in the third embodiment. The controller considers all candidate link NSS, operating bands and device capability combinations, wherein candidate devices are all devices within the mesh network coupled to the controller. The basic score calculation for the first and second embodiments considers bandwidth, RSSI, operating band, NSS etc. For the third embodiment, the controller also determines a rate the STA will obtain if it connects to the AP, wherein there will be limitations according to the STA antenna configuration.

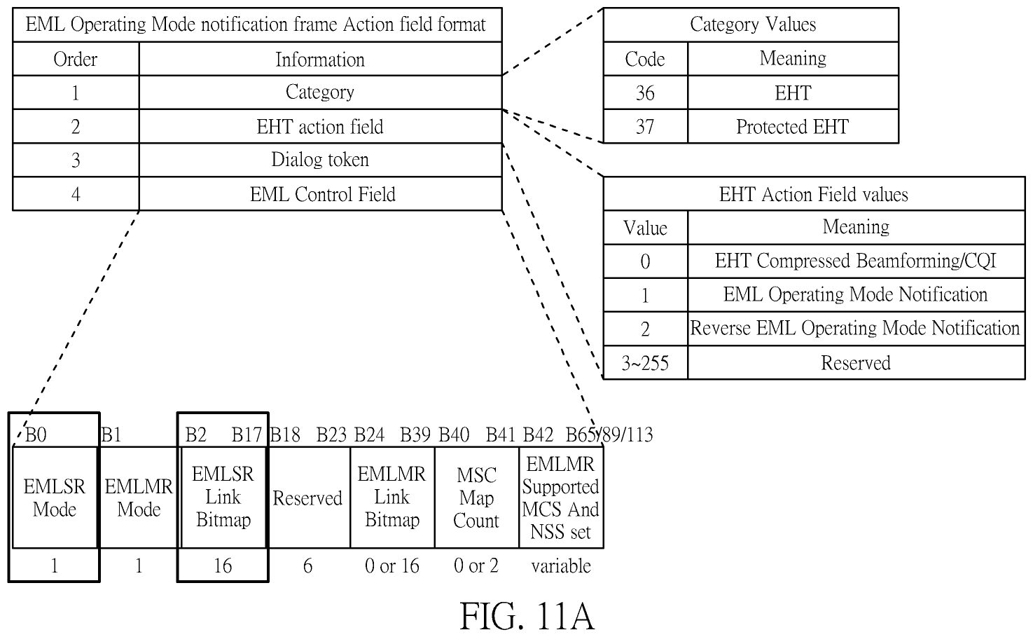

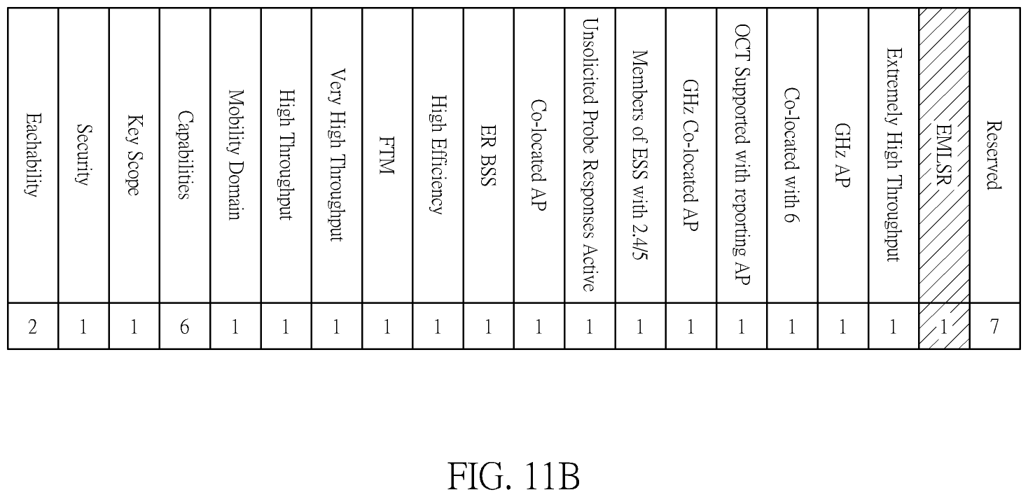

As detailed in the above, the invention provides two modified action frames for carrying out the method of the present invention. Refer to FIG. 11A which illustrates a reverse OMN frame according to an exemplary embodiment of the present invention. The OMN frame is well-known in the art and is sent from a STA to an AP for informing the AP of the NSS and band configuration of the STA. In the reverse OMN frame illustrated in FIG. 11A, reserved bit 2 in the EHT Action field values is set to indicate that the direction of the OMN frame is reversed, i.e. sent from the controller to the STA. In this way, the controller can include information in the EML control field for indicating to the STA an optimized NSS and band configuration.

Refer to FIG. 11B, which is a diagram of a BTM request according to an exemplary embodiment of the present invention. A reserved bit in the neighbour report of the BTM request is set, which indicates that an EMLSR control field is added in the neighbour report, including the controller's steering decision, wherein the EMLSR control field will be of the same format as that shown in FIG. 11A.

By providing RSSI thresholds corresponding to operating bands within a mesh network and comparing an RSSI of a STA connected to the controller with the thresholds, the controller can determine when a steering decision for the STA should be made. The controller can carry out score computations to determine at least an optimized NSS configuration for the STA, as well as an optimized operating band and multi-link device connection, and use reserved bits in action frames to send this optimized information to the STA, thereby enabling the STA to move through the mesh network while maintaining a highest link quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller within a mesh network comprising at least a station (STA) associated with the controller, the controller arranged to:
set a plurality of received signal strength intensity (RSSI) thresholds respectively corresponding to a plurality of operating bands of the controller, when an RSSI of the STA crosses one of the plurality of set thresholds, performing a calculation to determine respective scores of all enabled links of the STA, according to the calculation, determining a best number of spatial streams (NSS) configuration of the STA, and sending an action frame to the STA for informing the STA to update its NSS configuration.

2. The controller of claim 1, wherein the action frame is an MU-RTS frame.

3. The controller of claim 1, wherein the enabled links are an initial antenna configuration of the STA when the STA joins the mesh network.

4. The controller of claim 3, wherein the STA support an NSS configuration of 2×2 and (1×1+1×1).

5. The controller of claim 1, further arranged to perform a calculation to determine respective scores of all supported links of the STA, and according to the calculation, determine a best band of operation of the NSS configuration;
wherein the action frame further informs the STA which band value to use with which NSS link.

6. The controller of claim 5, wherein the action frame is a reverse operating mode notification frame which sets a bit in a reserved field of an EHT Action field to indicate the frame is sent from the controller to the STA, and the NSS configuration and operating band value information are written in an EMLSR link bitmap section of an EML control field of the action frame.

7. The controller of claim 5, wherein when an RSSI of the STA exceeds one of the RSSI thresholds, the NSS configuration will be upgraded from a 2×2 on a lower operating band corresponding to the RSSI threshold to a 2×2 on a higher operating band.

8. The controller of claim 5, wherein when an RSSI of the STA is less than one of the RSSI thresholds, the NSS configuration of the STA will be changed from a 2×2 on a higher operating band corresponding to the RSSI threshold to a 1×1 on the higher operating band and a 1×1 on a lower operating band.

9. The controller of claim 5, wherein the mesh network further comprises an access point (AP) not associated with the STA, the controller is arranged to define a current RSSI of the STA with the controller, a current RSSI of the STA with the non-associated AP, and a plurality of thresholds respectively associated with operating bands of the AP, when the current RSSI of the STA with the controller is less than the current RSSI of the STA with the non-associated AP, the controller compares the plurality of thresholds respectively associated with operating bands of the AP with the current RSSI of the STA with the non-associated AP and sends a request instructing the STA to connect to the AP.

10. The controller of claim 9, wherein the controller is further arranged to perform a calculation to determine an NSS and band configuration for the STA to be associated with the AP, and includes the information in the request.

11. The controller of claim 9, wherein when the STA is still associated with the controller, the request is a BTM request.

12. The controller of claim 9, wherein when the STA is not associated with the controller, the request is an enhanced mandate steering request sent from the controller to the AP, for instructing the AP to send an EMLSR BTM request to the STA.

13. The controller of claim 1, wherein each RSSI threshold further comprises an offset.

14. A method for updating an NSS configuration of a STA associated with a controller within a mesh network, the method comprising:
utilizing the controller to set a plurality of received signal strength intensity (RSSI) thresholds respectively corresponding to a plurality of operating bands of the controller;
when an RSSI of the STA crosses one of the plurality of set thresholds, performing a calculation to determine respective scores of all enabled links of the STA;
according to the calculation, determining a best number of spatial streams (NSS) configuration of the STA; and
sending an action frame to the STA for informing the STA to update its NSS configuration.

15. The method of claim 14, wherein the action frame is an MU-RTS frame.

16. The method of claim 14, wherein the enabled links are an initial antenna configuration of the STA when the STA joins the mesh network.

17. The method of claim 16, wherein the STA supports an NSS configuration of 2×2 and (1×1+1×1).

18. The method of claim 14, further comprising:
performing a calculation to determine respective scores of all supported links of the STA; and
according to the calculation, determining a best band of operation of the NSS configuration;
wherein the action frame further informs the STA which band value to use with which NSS link.

19. The method of claim 18, wherein the action frame is a reverse operating mode notification frame which sets a bit in a reserved field of an EHT Action field to indicate the frame is sent from the controller to the STA, and the step of sending an action frame comprises writing NSS configuration and operating band value information in an EMLSR link bitmap section of an EML control field of the action frame.

20. The method of claim 18, further comprising:
when an RSSI of the STA exceeds one of the RSSI thresholds, upgrading the NSS configuration from a 2×2 on a lower operating band corresponding to the RSSI threshold to a 2×2 on a higher operating band.

21. The method of claim 18, further comprising:
when an RSSI of the STA is less than one of the RSSI thresholds, changing the NSS configuration of the STA from a 2×2 on a higher operating band corresponding to the RSSI threshold to a 1×1 on the higher operating band and a 1×1 on a lower operating band.

22. The method of claim 18, wherein the mesh network further comprises an access point (AP) not associated with the STA, and the method further comprises:
defining a current RSSI of the STA with the controller, a current RSSI of the STA with the non-associated AP, and a plurality of thresholds respectively associated with operating bands of the AP;
when the current RSSI of the STA with the controller is less than the current RSSI of the STA with the non-associated AP, comparing the plurality of thresholds respectively associated with operating bands of the AP with the current RSSI of the STA with the non-associated AP; and
sending a request instructing the STA to connect to the AP.

23. The method of claim 22, further comprising:
performing a calculation to determine an NSS and band configuration for the STA to be associated with the AP, and including the information in the request.

24. The method of claim 22, wherein when the STA is still associated with the controller, the request is a BTM request.

25. The method of claim 22, wherein when the STA is not associated with the controller, the request is an enhanced mandate steering request sent from the controller to the AP, for instructing the AP to send an EMLSR BTM request to the STA.

26. The method of claim 14, wherein each RSSI threshold further comprises an offset.
